(19) United States
(12) Patent Application Publication
(10) Pub. No.: US 2026/0137067 A1
(43) Pub. Date: May 21, 2026

(54) APPARATUS AND METHODS FOR A FLYING INSECT CONTROL FEEDER

(71) Applicant: Aculeo Technologies LLC, Tucson, AZ (US)

(72) Inventors: Taylor Thoenes, Tucson, AZ (US); Steve Thoenes, Tucson, AZ (US)

(73) Assignee: Aculeo Technologies LLC, Tucson, AZ (US)

(21) Appl. No.: 19/382,058

(22) Filed: Nov. 6, 2025

Related U.S. Application Data
(60) Provisional application No. 63/735,410, filed on Dec. 18, 2024.
(60) Provisional application No. 63/721,943, filed on Nov. 18, 2024.

(51) Int. Cl. A01M 1/10; A01M 1/02; A01M 1/20

(52) U.S. Cl. CPC A01M 1/106; A01M 1/02; A01M 1/2016

(57) ABSTRACT

An apparatus and methods are provided for a flying insect control feeder to control the population of stinging insects in target areas. The feeder comprises an outer shell fastened to a base and an attractant chamber engaged with the base and housed inside the outer shell. Entry openings in the outer shell enable flying insects to enter the feeder. Landing surfaces enable the flying insects to land before walking through the entry openings. The landing surfaces can be coated with a suitable pesticide. The attractant chamber includes a cylindrical sidewall extending from an enclosed end to an open end that engages with the base. The base includes a floor that encloses the interior of the attractant chamber. The floor includes a port that allows an attractant syrup to gravity feed from the attractant chamber to a moat within the base.

### PRIORITY

This application claims the benefit of and priority to U.S. Provisional Application, entitled “Apparatus and Methods for a Flying Insect Trap,” filed on November 18, 2024, and having application serial number 63/721,943, and claims the benefit of and priority to U.S. Provisional Application, entitled “Apparatus and Methods for a Flying Insect Control Feeder,” filed on December 18, 2024, and having application serial number 63/735,410, the entirety of each of said applications being incorporated herein by reference.

### FIELD

Embodiments of the present disclosure generally relate to insect traps. More specifically, embodiments of the disclosure relate to an apparatus and methods for a flying insect control feeder to control the population of wasps and other stinging insects in target areas.

### BACKGROUND

Flying insects such as various social wasps, including paper wasps, hornets and yellow jackets, can be a significant nuisance and a potential hazard to people and animals in outdoor environments. Such flying insects typically are prevalent in rural settings as well as in well-developed residential areas. While wasps can be beneficial insects, controlling their population can be necessary, especially when they become a nuisance or pose a risk to people and pets.

Wasps become very aggressive when defending their nests or food sources, and thus wasps can disrupt outdoor activities like picnics, barbecues, and gardening. In addition, wasps are attracted to ripe fruits and can quickly decimate a harvest. Trapping queen wasps in the spring can help prevent the establishment of new nests, reducing the overall wasp population in target areas. Reducing the number of wasps in targeted areas can create a more peaceful and enjoyable outdoor space, as well as reduce the risk of painful stings, particularly for those that are allergic. Given the ubiquity of wasps and other stinging insects, there is an ongoing desire to develop flying insect traps for reducing the population of such insects in target areas.

### SUMMARY

An apparatus and methods are provided for a flying insect control feeder to control the population of stinging insects in target areas. The feeder comprises an outer shell fastened to a base and an attractant chamber engaged with the base and housed inside the outer shell. Entry openings in the outer shell enable flying insects to enter the feeder. Landing surfaces enable the flying insects to land before walking through the entry openings. The landing surfaces can be coated with a suitable pesticide. The attractant chamber includes a cylindrical sidewall extending from an enclosed end to an open end that engages with the base. The base includes a floor that encloses the interior of the attractant chamber. The floor includes a port that allows an attractant syrup to gravity feed from the attractant chamber to a moat within the base.

In an exemplary embodiment, an apparatus for controlling the population of flying insects in a target area, comprises: an outer shell fastened to a base; an attractant chamber engaged with the base and housed inside the outer shell; a moat that receives an attractant syrup from the attractant chamber; and one or more entry openings in the outer shell.

In another exemplary embodiment, each of the one or more entry openings is disposed between a pair of adjacent tabs disposed around an open bottom of the outer shell. In another exemplary embodiment, the one or more entry openings are configured to enable flying insects to enter the outer shell. In another exemplary embodiment, the apparatus further comprises a landing ring that is configured to be coupled with the base. In another exemplary embodiment, the landing ring comprises landing surfaces that provide stable locations for the flying insects to land before walking through the one or more entry openings.

In another exemplary embodiment, the outer shell comprises a hexagonal sidewall that extends from an enclosed top to multiple tabs disposed around an open bottom. In another exemplary embodiment, the multiple tabs comprises three tabs that are configured to be fastened onto the base by way of screws. In another exemplary embodiment, each of the multiple tabs includes a slot that receives a screw. In another exemplary embodiment, the hexagonal sidewall is configured to be attached to the base by sliding the multiple tabs over a hexagonal flange comprising the base, such that the screws slide into corresponding slots, and then tightening the screws. In another exemplary embodiment, the enclosed top includes one or more holes configured to receive a pheromone tube.

In another exemplary embodiment, the attractant chamber includes a substantially cylindrical sidewall that extends from an enclosed end to a circular edge that borders an open end. In another exemplary embodiment, the circular edge is configured to be engaged with a flange disposed in the base, such that the attractant chamber and the base form a substantially enclosed chamber for holding a volume of the attractant syrup. In another exemplary embodiment, the attractant chamber is configured to be coupled with base by inserting the circular edge into the flange and then twisting the attractant chamber to position ledges disposed uniformly around the circular edge underneath the overhanging portions disposed uniformly around the flange.

In another exemplary embodiment, a series of indentations is disposed around the circumference of the cylindrical sidewall near the enclosed end. In another exemplary embodiment, the series of indentations facilitate gripping the attractant cylinder during twisting the attractant chamber onto the base. In another exemplary embodiment, the series of indentations allow odors emitted from bait to pass outside the attractant chamber to encourage the flying insects to enter the outer shell through the one or more entry openings.

In another exemplary embodiment, the base cooperates with the attractant chamber to provide an enclosed chamber that holds a volume of the attractant syrup. In another exemplary embodiment, the base includes a flange that receives an open end of the attractant chamber and surrounds a floor. In another exemplary embodiment, the floor is configured to substantially enclose the attractant chamber. In another exemplary embodiment, the floor includes a port that allows the attractant syrup to gravity feed from the attractant chamber to the moat.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an upper isometric view of an exemplary embodiment of a flying insect control feeder, according to the present disclosure;

FIG. 2 illustrates a lower isometric view of the flying insect control feeder of FIG. 1 in accordance with the present disclosure;

FIG. 3 illustrates an exploded view of the flying insect control feeder of FIG. 1, according to the present disclosure;

FIG. 4 illustrates a perspective view of an exemplary embodiment of a flying insect control feeder in accordance with the present disclosure;

FIG. 5 illustrates a perspective view of an exemplary embodiment of an attractant chamber, a base, and a landing ring comprising the flying insect control feeder of FIG. 4, according to the present disclosure;

FIG. 6 illustrates a perspective view of an exemplary embodiment of a base and a landing ring comprising the flying insect control feeder of FIG. 4 in accordance with the present disclosure; and

FIG. 7 illustrates a perspective view of the landing ring disassembled from the base of FIG. 6, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the flying insect control feeder and methods disclosed herein may be practiced without these specific details. In other instances, specific numeric references such as “first container,” may be made. However, the specific numeric reference should not be interpreted as a literal sequential order but rather interpreted that the “first container” is different than a “second container.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Flying insects such as various social wasps, including paper wasps, hornets and yellow jackets, can be a significant nuisance and a potential hazard to people and animals in outdoor environments. While such insects can be beneficial to the environment, controlling their population can be necessary, especially when they become a nuisance or pose a risk to people and pets. Reducing the number of wasps, or other stinging insects, in targeted areas can create a more peaceful and enjoyable outdoor space, as well as reduce the risk of painful stings, particularly for those that are allergic. Embodiments described herein provide apparatuses and methods for reducing the population of stinging insects in target areas.

FIGS. 1-3 illustrate an exemplary embodiment of a flying insect control feeder 100 (hereinafter, “feeder 100”), according to the present disclosure. Feeder 100 can be used to control the population of any of various social wasps, including paper wasps, hornets and yellow jackets. Herein, the term “wasp” is used as a generic name applied to insects of the order Hymenoptera which includes particularly paper wasps, hornets and yellow jackets. It is contemplated, however, that in some instances the feeder 100 may be used to control the population of any insect species, including honeybees, in target areas, as desired.

Feeder 100 comprises a generally rigid material, such as metal or plastic. Plastic embodiments may be formed by way of injection molding, 3D printing, or other suitable processes. In some embodiments, the rigid material comprises a transparent plastic that enables direct observation of the flying insects inside the feeder 100.

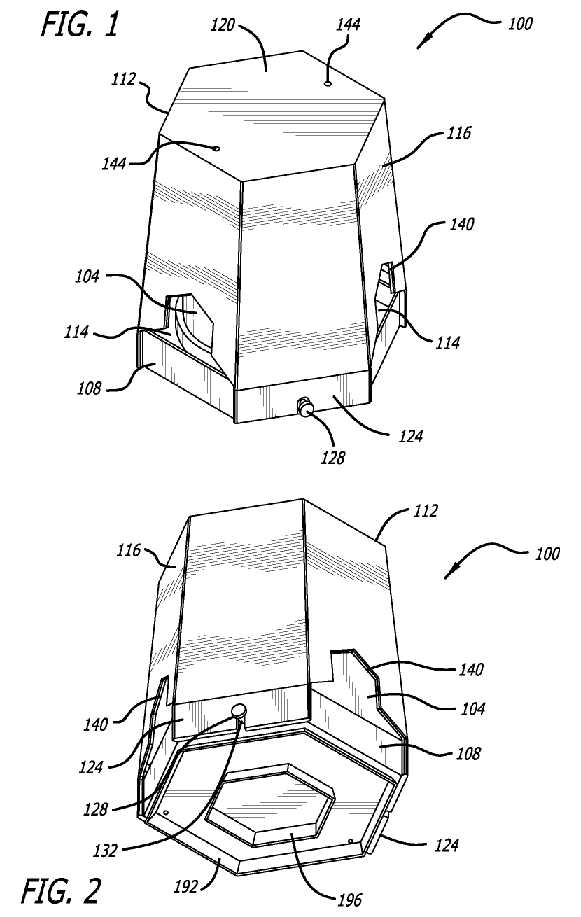

Feeder 100 broadly comprises an attractant chamber 104 that is engaged with a base 108 and housed inside an outer shell 112. A moat 114 disposed in the base 108 is replenished with an attractant syrup that gravity feeds from the attractant chamber 104, as described herein. The outer shell 112 comprises a hexagonal sidewall 116 that extends from an enclosed top 120 to multiple tabs 124 disposed around an open bottom. In the illustrated embodiment, there are three tabs 124 configured to be fastened onto the base 108 by way of screws 128. As shown in FIGS. 1-2, each of the tabs 124 includes a slot 132 that receives a screw 128. As will be appreciated, the outer shell 112 can be attached to the base 108 by sliding the tabs 124 over a hexagonal flange 136 comprising the base 108, such that the screws 128 slide into corresponding slots 132, and then tightening the screws 128. Holes 144 disposed in the enclosed top 120 facilitate positioning a pheromone tube (not shown) on top of the outer shell 112. It is contemplated that the odors of the pheromones and the attractant syrup will attract the target flying insects to the feeder 100. In some embodiments, however, the holes 144 may be used for suspending the feeder 100 from a suitable support by way of a hanger such as a hook, wire, string, strap or the like (not shown). Preferably, the feeder 100 is to be positioned in a location having free access by the target flying insects.

As shown in FIGS. 1-2, the outer shell 112 includes an entry opening 140 disposed between each pair of adjacent tabs 124. Entry openings 140 are configured to enable flying insects to land and then enter the outer shell 112. In some embodiments, a toxic pesticide can be applied to the areas around the entry openings 140 so that the target insects must cross through the pesticide to reach the moat 114. In the illustrated embodiment, outer shell 112 includes three entry openings 140 and three tabs 124. It should be noted, however, that in other embodiments. any number of entry openings 140 and tabs 124 can be incorporated into the feeder 100, without limitation.

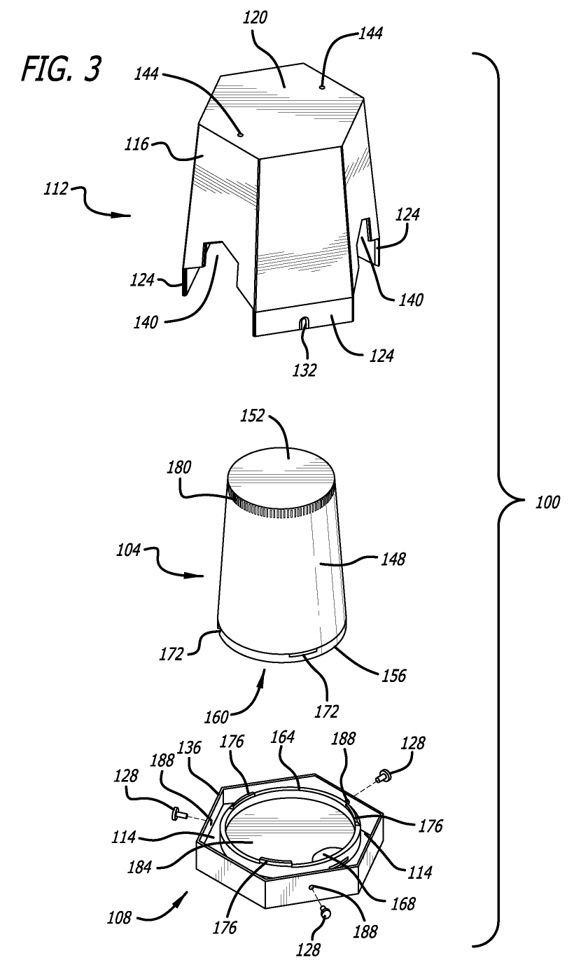

As best shown in FIG. 3, attractant chamber 104 includes a substantially cylindrical sidewall 148 that extends from an enclosed end 152 to a circular edge 156 that borders an open end 160. Circular edge 156 is configured to be engaged with a flange 164 disposed in the base 108, such that the attractant chamber 104 and the base 108 form a substantially enclosed chamber for holding an attractant syrup that can gravity feed to the moat 114 through a port 168. Multiple ledges 172 are disposed uniformly around the circular edge 156 and are configured to engage with overhanging portions 176 disposed uniformly around the flange 164. Thus, attractant chamber 104 can be coupled with base 108 by inserting the circular edge 156 into the flange 164 and then twisting the attractant chamber 104 to position the ledges 172 underneath the overhanging portions 176. As shown in FIG. 3, a series of indentations 180 are disposed around the circumference of the cylindrical sidewall 148 near the enclosed end 152. The indentations 180 facilitate gripping the attractant chamber 104 during twisting the attractant chamber 104 to position the ledges 172 underneath the overhanging portions 176.

With continuing reference to FIG. 3, the base 108 comprises a bottom portion of feeder 100 that cooperates with the attractant chamber 104 to provide an enclosed volume that gravity feeds an attractant syrup to the moat 114. As described above, base 108 includes a flange 164 that receives the open end 160 of the attractant chamber 104. Overhanging portions 176 disposed around the flange 164 and ledges 172 disposed around the circumferential edge 156 comprise a “twist lock” that enables attaching the attractant chamber 104 to the base 108. Further, base 108 includes a floor 184 that is disposed within the flange 164. The floor 184 includes a port 168 that allows the attractant syrup to gravity feed from the attractant chamber 104 to the moat 114 surrounding the flange 164.

As shown in FIG. 3, base 108 includes a hexagonal flange 136 configured to receive tabs 124 comprising the outer shell 112. As described herein, in the illustrated embodiment, there are three tabs 124 configured to be fastened onto the base 108 by way of screws 128. As shown in FIGS. 1-2, each of the tabs 124 includes a slot 132 that receives a screw 128. As will be appreciated, the outer shell 112 can be attached to the base 108 by sliding the tabs 124 over a hexagonal flange 136 comprising the base 108, such that the screws 128 slide into corresponding slots 132, and then tightening the screws 128. Holes 188 disposed in the hexagonal flange 136 facilitate tightening the screws 128 into the base 108.

In the illustrated embodiment of FIG. 2, the base 108 includes an outer structural foot 192 and an inner structural foot 196. It is contemplated that the outer and inner structural feet 192, 196 are configured to support the feeder 100 when it is supported by a horizontal surface. Further, in some embodiments, one or both of the outer and inner structural feet 192, 196 may be omitted, as desired, without limitation.

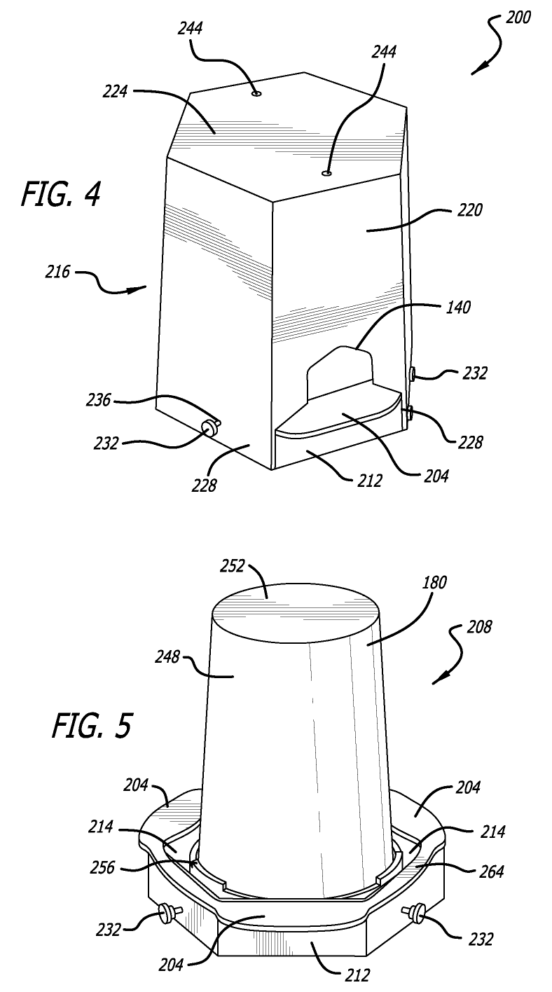

FIG. 4 illustrates an exemplary embodiment of a flying insect control feeder 200 in accordance with the present disclosure. The feeder 200 is substantially similar to the feeder 100, shown in FIGS. 1-3, with the exception that the feeder 200 includes a landing surface 204 disposed in each entry opening 140. The landing surfaces 204 provide stable locations where flying insects can land before walking through the entry openings 140 into the feeder 200. It is contemplated that a toxic pesticide can be applied to the landing surfaces 204 so that the target insects must cross through the pesticide to enter the feeder 200. Feeder 200 can be used to control the population of any of various social wasps, including paper wasps, hornets and yellow jackets, as well as honeybees in target areas, as desired.

Feeder 200 comprises a generally rigid material, such as metal or plastic. Plastic embodiments may be formed by way of injection molding, 3D printing, or other suitable processes. In some embodiments, the rigid material comprises a transparent plastic that enables direct observation of the flying insects inside the feeder 200.

Similarly to feeder 100, feeder 200 comprises an attractant chamber 208 (see FIG. 5) that is engaged with a base 212 and housed inside an outer shell 216. The attractant chamber 208 can supply an attractant syrup to a moat 214 in the base 212. The outer shell 216 comprises a hexagonal sidewall 220 that extends from an enclosed top 224 to multiple tabs 228 disposed around an open bottom. In the illustrated embodiment, there are three tabs 228 configured to be fastened onto the base 212 by way of screws 232. As shown in FIG. 4, each of the tabs 228 includes a slot 236 that receives a screw 232. As will be appreciated, the outer shell 216 can be attached to the base 212 by sliding the tabs 228 over a hexagonal flange 240 (see FIG. 7) comprising the base 212, such that the screws 232 slide into corresponding slots 236, and then tightening the screws 232. Holes 244 disposed in the enclosed top 224 facilitate positioning a pheromone tube (not shown) on top of the outer shell 216. It is contemplated that the odors of the pheromones and the attractant syrup will attract the target flying insects to the feeder 200. In some embodiments, however, the holes 244 may be used to suspend the feeder 200 from a suitable support by way of a hanger such as a hook, wire, string, strap or the like (not shown). Preferably, the feeder 200 is to be positioned in a location having free access by the target flying insects.

As shown in FIGS. 1-2, the outer shell 216 includes an entry opening 140 disposed between each pair of adjacent tabs 228. Entry openings 140 are configured to enable flying insects to land and then enter the outer shell 216. In the illustrated embodiment, outer shell 216 includes three entry openings 140 and the three tabs 228. It should be noted, however, that in other embodiments. any number of entry openings 140 and tabs 228 can be incorporated into the feeder 200, without limitation.

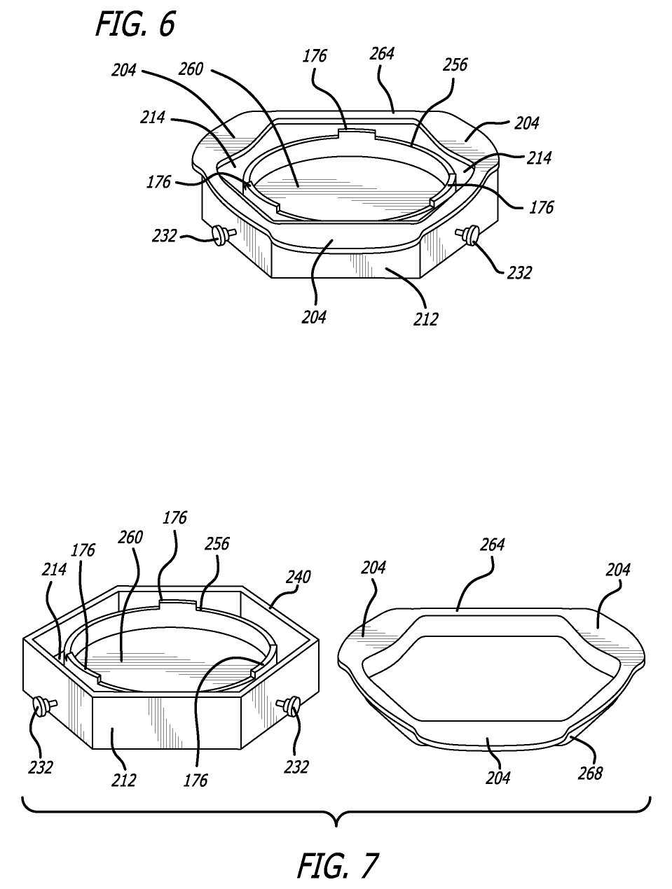

As best shown in FIG. 5, attractant chamber 208 includes a substantially cylindrical sidewall 248 that extends from an enclosed end 252 to a circular edge that is configured to be engaged with a flange 256 comprising the base 212. The attractant chamber 208 and the base 212 form a substantially enclosed chamber for holding an attractant syrup that can gravity feed to the moat 214 through a port 168 (see FIG. 3). As described herein, the base 212 includes overhanging portions 176 (see FIGS. 6-7) disposed uniformly around the flange 256 and configured to engage with ledges 172 (see FIG. 3) disposed around the circular edge of the attractant chamber 208. Thus, attractant chamber 208 can be coupled with base 212 by inserting the circular edge into the flange 256 and then twisting the attractant chamber 208 to position the ledges 172 underneath the overhanging portions 176. As shown in FIG. 5, a series of indentations 180 are disposed around the circumference of the cylindrical sidewall 248 near the enclosed end 252. The indentations 180 facilitate gripping the attractant chamber 208 during twisting the attractant chamber 208 to position the ledges 172 underneath the overhanging portions 176.

As shown in FIG. 6, the base 212 comprises a bottom portion of feeder 200 that cooperates with the attractant chamber 208 to provide an enclosed volume that gravity feeds an attractant syrup to the moat 214. As described above, base 212 includes a flange 256 that receives the open end of the attractant chamber 208 (see, for example, open end 160 of FIG. 3). Overhanging portions 176 disposed around the flange 256 and ledges 172 disposed around the open end 160 comprise a “twist lock” that enables attaching the attractant chamber 208 to the base 212. Further, base 212 includes a floor 260 that is disposed within the flange 256. The floor 260 includes a port 168 (see, for example, FIG. 3) that allows the attractant syrup to gravity feed from the attractant chamber 208 to the moat 214 surrounding the flange 256.

As shown in FIGS. 6-7, a landing ring 264 may be coupled with the base 212. The landing ring 264 comprises the landing surfaces 204, discussed hereinabove, and a hexagonal portion 268. The hexagonal portion 268 is configured to slide within the hexagonal flange 240, as shown in FIG. 6, such that a landing surface 240 is supported in each entry opening 140, as shown in FIG. 4. The landing surfaces 204 provide stable locations where flying insects can land before walking through the entry openings 140 into the feeder 200. It is contemplated that a toxic pesticide can be applied to the landing surfaces 204 so that the target insects must cross through the pesticide to enter the feeder 200. The landing ring 264 provides a simple means for including the landing surfaces 204 in the feeder 200.

While the flying insect control feeder and methods have been described in terms of particular variations and illustrative figures, those of ordinary skill in the art will recognize that the flying insect control feeder is not limited to the variations or figures described. In addition, where methods and steps described above indicate certain events occurring in certain order, those of ordinary skill in the art will recognize that the ordering of certain steps may be modified and that such modifications are in accordance with the variations of the flying insect control feeder. Additionally, certain of the steps may be performed concurrently in a parallel process, when possible, as well as performed sequentially as described above. To the extent there are variations of the flying insect control feeder, which are within the spirit of the disclosure or equivalent to the flying insect control feeder found in the claims, it is the intent that this patent will cover those variations as well. Therefore, the present disclosure is to be understood as not limited by the specific embodiments described herein, but only by scope of the appended claims.

What is claimed is:

1. An apparatus for controlling the population of flying insects in a target area, comprising:
an outer shell fastened to a base;
an attractant chamber engaged with the base and housed inside the outer shell;
a moat that receives an attractant syrup from the attractant chamber; and
one or more entry openings in the outer shell.

2. The apparatus of claim 1, wherein each of the one or more entry openings is disposed between a pair of adjacent tabs disposed around an open bottom of the outer shell.

3. The apparatus of claim 1, wherein the one or more entry openings are configured to enable flying insects to enter the outer shell.

4. The apparatus of claim 1, further comprising a landing ring that is configured to be coupled with the base.

5. The apparatus of claim 4, wherein the landing ring comprises landing surfaces that provide stable locations for the flying insects to land before walking through the one or more entry openings.

6. The apparatus of claim 1, wherein the outer shell comprises a hexagonal sidewall that extends from an enclosed top to multiple tabs disposed around an open bottom.

7. The apparatus of claim 6, wherein the multiple tabs comprise three tabs that are configured to be fastened onto the base by way of screws.

8. The apparatus of claim 6, wherein each of the multiple tabs includes a slot that receives a screw.

9. The apparatus of claim 8, wherein the hexagonal sidewall is configured to be attached to the base by sliding the multiple tabs over a hexagonal flange comprising the base, such that the screws slide into corresponding slots, and then tightening the screws.

10. The apparatus of claim 6, wherein the enclosed top includes one or more holes configured to receive a pheromone tube.

11. The apparatus of claim 1, wherein the attractant chamber includes a substantially cylindrical sidewall that extends from an enclosed end to a circular edge that borders an open end.

12. The apparatus of claim 11, wherein the circular edge is configured to be engaged with a flange disposed in the base, such that the attractant chamber and the base form a substantially enclosed chamber for holding a volume of the attractant syrup.

13. The apparatus of claim 12, wherein the attractant chamber is configured to be coupled with base by inserting the circular edge into the flange and then twisting the attractant chamber to position ledges disposed uniformly around the circular edge underneath the overhanging portions disposed uniformly around the flange.

14. The apparatus of claim 11, wherein a series of indentations is disposed around the circumference of the cylindrical sidewall near the enclosed end.

15. The apparatus of claim 14, wherein the series of indentations facilitate gripping the attractant cylinder during twisting the attractant chamber onto the base.

16. The apparatus of claim 15, wherein the series of indentations allow odors emitted from bait to pass outside the attractant chamber to encourage the flying insects to enter the outer shell through the one or more entry openings.

17. The apparatus of claim 1, wherein the base cooperates with the attractant chamber to provide an enclosed chamber that holds a volume of the attractant syrup.

18. The apparatus of claim 17, wherein the base includes a flange that receives an open end of the attractant chamber and surrounds a floor.

19. The apparatus of claim 18, wherein the floor is configured to substantially enclose the attractant chamber.

20. The apparatus of claim 19, wherein the floor includes a port that allows the attractant syrup to gravity feed from the attractant chamber to the moat.
